(19) United States
(12) Patent Application Publication
(10) Pub. No.: US 2018/0122151 A1
(43) Pub. Date: May 3, 2018

(54) PLACE MANAGEMENT METHOD AND PLACE MANAGEMENT SYSTEM

(71) Applicants: INVENTEC (PUDONG) TECHNOLOGY CORPORATION, Shanghai City (CN); INVENTEC CORPORATION, Taipei City (TW)

(72) Inventor: Huang-Hsiang CHIANG, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/473,415

(22) Filed: Mar. 29, 2017

(30) Foreign Application Priority Data
Oct. 27, 2016 (CN) 201610950182.8

(51) Int. Cl. G07B 15/00; G06Q 20/10; G06K 19/10; G06K 7/14

(52) U.S. Cl. CPC G07B 15/00; G06Q 20/10; G06Q 2240/00; G06K 7/1417; G06K 19/10

(57) ABSTRACT

A place management method and a place management system are provided. The place management method includes the following steps: generating a first identification code according to an entering request, and transmitting the first identification code to a client; determining whether the first identification code from the client is read by an identification module; generating an entering authorization message corresponding to an object and recording a corresponding first time when the first identification code is read by the identification module; receiving a leaving message, and generating a second identification code according to the first time and a second time corresponding to the leaving message, and sending the second identification code to the client; and generating a leaving authorization message corresponding to the object when the second identification code is read by the identification module.

### CROSS-REFERENCE TO RELATED APPLICATIONS

This non-provisional application claims priority under 35 U.S.C. § 119(a) on Patent Application No(s) 201610950182.8 filed in China on Oct. 27, 2016 the entire contents of which are hereby incorporated by reference.

### TECHNICAL FIELD

The disclosure relates to a place management method and a place management system, more particularly to a place management method and a place management system using the technique of identification code.

### BACKGROUND

In general, tickets and tokens are applied in the present payment and management methods of a parking lot. When a vehicle enters a parking lot, the administrator provides a ticket or a token to a driver of the vehicle. When the vehicle leaves the parking lot, tickets and tokens will be returned for calculating the parking fee.

However, those tickets and tokens are easily lost by users, and even some vendors require users to go to a service counter for changing tickets into tokens. These situations cause inconveniences and troubles of keeping tickets and tokens to drives. Moreover, sometimes drivers forget the positions of their vehicles or the floor corresponding to their vehicles and it causes a significant inconvenience to drivers when the drivers search for their vehicles.

### SUMMARY

The present disclosure provides a place management method. The place management method includes the following steps: generating a first identification code according to an entering request and transmitting the first identification code to a client; determining whether the first identification code from the client is read by an identification module; generating an entering authorization message of a place corresponding to an object and recording a first time corresponding to the entering authorization message when the first identification code is read by the identification module; receiving a leaving message and generating a second identification code according to the first time and a second time corresponding to the leaving message and transmitting the second identification code to the client; generating a leaving authorization message of the place corresponding to the object when the second identification code is read by the identification module.

According to one embodiment of the present disclosure, the place management method further includes the following steps: reading position information of the object in the place; capturing an image of the object according to the position information; transmitting the image to the client.

According to another embodiment of the present disclosure, the second identification code has an effective period.

According to another embodiment of the present disclosure, the place management method further includes the following steps: receiving a payment message; generating the leaving message according to the payment message.

According to another embodiment of the present disclosure, the effective period of the second identification code is related to a third time of receiving the payment message.

According to another embodiment of the present disclosure, the first identification code and the second identification code are two-dimensional barcodes, and the identification module is a two-dimensional barcode scanner.

The present disclosure provides a place management system including a cloud processing module, an identification generating module and an identification module. The cloud processing module is configured to receive an entering request from a client. The identification code generating module is configured to generate a first identification code according to the entering request and the first identification code is transmitted to the client by the cloud processing module. The identification module is configured to determine whether the first identification code from the client is read and an entering authorization message of a place corresponding to an object is generated when the first identification code is read by the identification module. Wherein, the cloud processing module records a first time corresponding to the entering authorization message. The identification code generating module generates a second identification code according to the first time and a second time corresponding to a leaving message when the leaving message is received by the cloud processing module. The second identification code is transmitted to the client by the cloud processing module, and a leaving authorization message of the place corresponding to the object is generated when the second identification code is read by the identification module.

According to one embodiment of the present disclosure, the place management system further comprises a plurality of image capturing modules, wherein the cloud processing module further reads position information of the object in the place and drives at least one of the plurality of image capturing modules to capture an image of the object according to the position information. The cloud processing module transmits the image to the client.

According to another embodiment of the present disclosure, the place management system further includes a toll module configured to receive a payment message and generate the leaving message according to the payment message.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a place management system in one embodiment of the present disclosure;

FIG. 2 is a schematic diagram of a place management system in one embodiment of the present disclosure; and

FIG. 3 is a flow chart of a place management method in one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

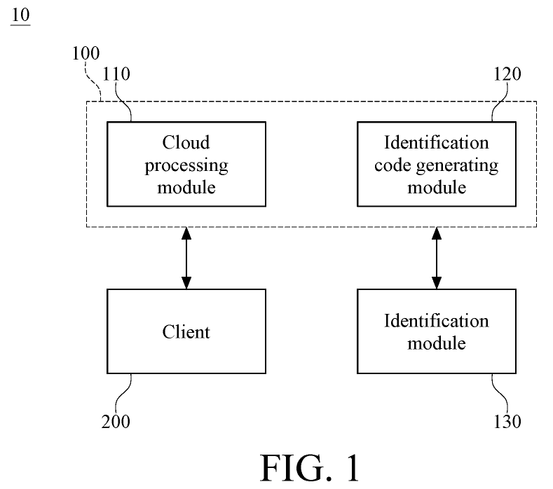

FIG. 1 is a schematic diagram of a place management system 10 in one embodiment of the present disclosure. As shown in FIG. 1, the place management system 10 includes a cloud processing module 110, an identification code generating module 120 and an identification module 130. In one example, the cloud processing module 110, the identification code generating module 120 and the identification module 130 are processors or other kinds of chips. For convenience, the place management system 10 is arranged to control for entering and leaving a parking lot as well as a charging mechanism corresponding the parking lot. However, in other embodiments, the place management system is another type of place such as a court or a gym, etc. The present disclosure is not limited to the above embodiment.

The cloud processing module 110 and the identification code generating module 120 are disposed in a server 100 used for managing the parking lot. The identification module 130 is disposed in a reader of a gateway of the parking lot so that drivers are able to provide relative information to the identification module 130 for verification. However, the present disclosure is not limited to the embodiments mentioned above. More descriptions regarding operations between each module will be provided.

The cloud processing module 110 is configured to receive an entering request of a client 200. In one example, the client 200 is a portable device such as a smart phone, a personal digital assistant (PDA), a personal computer or other device. For example, a user is able to log in a user interface in advanced via a an application of a smart phone, and select one parking lot in the user interface for the parking reservation to send an entering request. Moreover, the user is also able to input the license plate number in the user interface when making the parking reservation. In other words, the entering request includes a license plate number or other relative information of a user. After the cloud processing module 110 receives an entering request, the cloud processing module 110 further determines whether there are extra parking spaces in the parking lot.

The identification code generating module 120 is configured to generate a first identification code according to the entering request, and transmit a first identification code to the client 200 by the cloud processing module 110. In one example, the first identification code is an encrypted image such as a Quick Response Code (QR Code) in a two dimensional barcode. In other example, the first identification code is a Radio Frequency Identification (RFID) signal, a Near Field Communication (NFC) signal or other type of identification information. The present disclosure is not limited to the above embodiment. In the following example, a QR code is considered as the first identification code. Correspondingly, the identification module 30 is a two dimensional barcode scanner.

For example, when the cloud processing module 110 determines that there are available parking spaces in the parking lot, the identification code generating module 120 generates a first identification code corresponding to the parking lot. Correspondingly, after the use receives the QR code via the smart phone, the user drives to the gateway of the parking lot to show the QR code for verification.

The identification module 130 is configured to determine whether the first identification code of the client 200 is read. When the identification module 130 reads the first identification code, an entering authorization message of the place corresponding to the object is generated. In the embodiment, the object is the vehicle of the user. For example, the identification module 130 decodes the OR code shown in the smart phone to determine whether the decoded QR code meets the first identification code sent from the processing module 110. When it is determined that the decoded QR code meets the first identification code, the entering authorization message of the parking lot is generated. The entering authorization message is transmitted to a fence of the parking lot so that the user is able to drive into the parking lot.

The cloud processing module 110 records a first time corresponding to the entering authorization message. The parking fee will be calculated according to the first time.

Correspondingly, when the user would like to leave the parking lot, the user is also able to log in the user interface via the smart phone to send a leaving request. When the cloud processing module 110 receives the leaving message, the identification code generating module 120 generates a second identification code according to the first time and a second time corresponding to the leaving message. In an embodiment of the present disclosure, the second identification code is a QR code. The cloud processing module 110 transmits the second identification code to the client 200.

When the identification module 130 reads the second identification code, a leaving authorization message of the place corresponding to the object is generated. The leaving authorization message is transmitted to the fence of the parking lot so that the user is able to drive out of the parking lot.

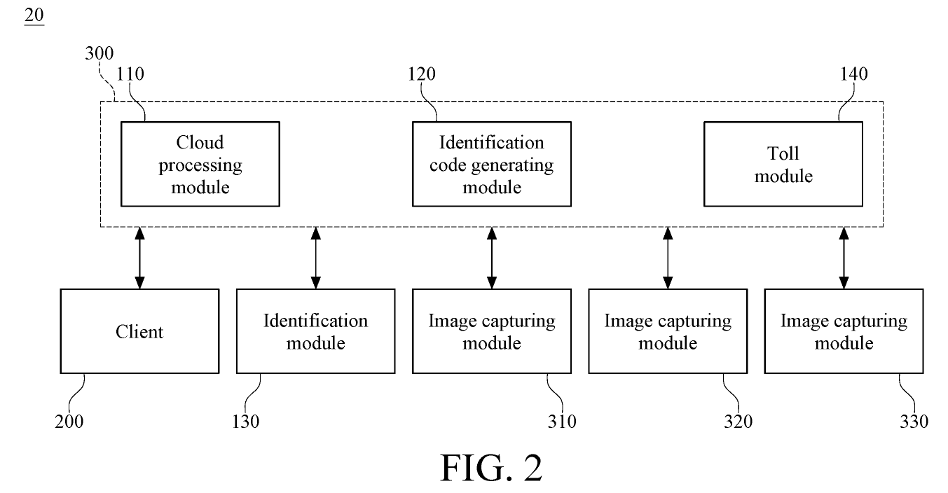

FIG. 2 is a schematic diagram of a place management system 20 in one embodiment of the present disclosure. As shown in FIG. 2, the place management system 20 includes a cloud processing module 110, an identification code generating module 120, an identification module 130, a toll module 140 and a plurality of image capturing module 310-330. In one embodiment, the cloud processing module 110, the identification code generating module 120, the identification module 130 and the toll module 140 are microprocessor or other types of chips. The image capturing modules 310-330 are cameras or other kinds of image sensors. In one embodiment, the cloud processing module 110, the identification code generating module 120 and the toll module 140 are disposed in the server 100. The image capturing module 310-330 are disposed in corners of the parking lot or near the parking lot. The cloud processing module 110, the identification code generating module 120 and the identification module 130 in FIG. 2 also perform the functions in the embodiment of the FIG. 1. Detailed descriptions regarding other functions and new modules will be provided in the following paragraphs.

When the user sends the entering request, receives the QR code and displays the QR code via the smart phone to pass the verification of the identification module 130, then the user is able to go to the parking space for parking.

In the embodiment of the present disclosure, the cloud processing module 110 further read position information of the object in the place, and drives one of the image capturing module 310-330 to capture an image of the object according to the position information.

The cloud processing module 110 transmits the image to the client 200. The position information is the location where the user park in the parking lot. For example, after the user parks, the user is still able to log in the user interface for checking a real-time image of the vehicle when shopping in a shopping mall or working in an office near the parking lot.

In one embodiment, when the user selects a parking lot in the user interface, the user is allowed to select a specific parking space in the parking lot at the same time. Thus, the position information is generated when the parking space is selected. In another embodiment, the user parks in any parking space of the parking lot. Because the user is allowed to input a license plate number in the user interface, one of the image capturing modules 310-330 tracks the vehicle by performing image recognition when the user is parking, so that the parking space corresponding to the vehicle is obtained.

In one embodiment, the position information includes floors of the parking lot, parking space number of the parking lot, etc. The position information is displayed in the user interface. Therefore, a reminder is provided to the user through the user interface so that the inconvenience of searching for the vehicle is avoided.

When the user would like to take the vehicle in the parking lot, the user pays the parking fee in the payment page of the user interface so that a payment message is generated. In one embodiment, the parking fee is paid by credit card online or membership deposit of the parking lot. The present disclosure is not limited to the above embodiment. In other embodiment, the user pays the parking fee over a toll machine in the parking lot. The present disclosure is not limited to the above embodiment.

Thereby, the toll module 140 receives the payment message and generates the leaving message according to the payment message. The toll module 140 transmits the leaving message to the cloud processing module 110 for generating the second identification code. In one embodiment of the present disclosure, the second identification code has an effective period. For example, after the user pays the parking fee successfully, the user should take the vehicle and leave the parking lot in the effective period such as half an hour, otherwise the user needs to pay an extra parking fee for extra occupation time. The effective period of the second identification code is related to a third time which the toll module 140 receives the payment message. For example, if the third time is 18:00, then the effective period is from 18:00 to 18:30.

The parking lot is taken as an example in the above embodiment. If a gym is taken as an example, then the user is allowed to manage the place for entering and leaving via a smart phone and the user will be charged according to the using period. In one embodiment, the real-time image corresponds to an object in a locker of the gym. The present disclosure may be applied to a variety of applications.

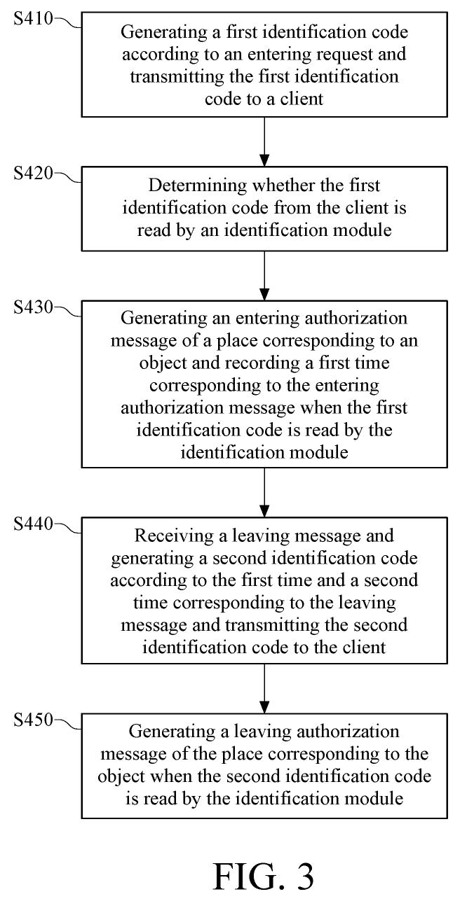

FIG. 3 is a flow chart of a place management method in one embodiment of the present disclosure. As shown in FIG. 3, the place management method in the embodiment of the present disclosure includes steps S410-S450.

In step S410, the identification code generating module 120 generates the first identification code according to the entering request received by the cloud processing module 110 and transmits the first identification code to the client 200 by the cloud processing module 110.

In step S420, the identification module 130 determines whether the first identification code of the client 200 is read.

In step S430, when the identification module 130 reads the first identification code, the entering authorization message of the place corresponding to the object is generated. The cloud processing module 110 records the first time corresponding to the entering authorization message.

In step S440, the cloud processing module 110 receives a leaving message, and the identification code generating module 120 generates the second identification code according to the first time and the second time corresponding to the leaving message. The second identification code is transmitted to the client 200 by the cloud processing module 110.

In step S450, the identification module 130 reads the second identification code, the leaving authorization message of the place corresponding to the object is generated.

The detailed descriptions regarding the above steps are mentioned in the previous paragraphs, and not repeated.

Based on the above descriptions, in the present disclosure, the first identification code and the second identification code are transmitted to the client, and identifications for entering and leaving the place are performed by the identification module. Moreover, the real-time image of the object is transmitted to the user for monitoring via the user interface, and parking fee is calculated automatically according to usage time of the user in the place. Thereby, the convenience of management and use of the place is raised.

What is claimed is:

1. A place management method, comprising:
generating a first identification code according to an entering request and transmitting the first identification code to a client;
determining whether the first identification code from the client is read by an identification module;
generating an entering authorization message of a place corresponding to an object and recording a first time corresponding to the entering authorization message when the first identification code is read by the identification module;
receiving a leaving message and generating a second identification code according to the first time and a second time corresponding to the leaving message and transmitting the second identification code to the client; and
generating a leaving authorization message of the place corresponding to the object when the second identification code is read by the identification module.

2. The place management method according to claim 1, wherein after the step of generating the entering authorization message of the place corresponding to the object and recording the first time corresponding to the entering authorization message when the first identification code is read by the identification module further comprises:
reading position information of the object in the place;
capturing an image of the object according to the position information; and
transmitting the image to the client.

3. The place management method according to claim 1, wherein the second identification code has an effective period.

4. The place management method according to claim 3, further comprising:
receiving a payment message; and
generating the leaving message according to the payment message.

5. The place management method according to claim 4, wherein the effective period of the second identification code is related to a third time of receiving the payment message.

6. The place management method according to claim 1, wherein the first identification code and the second identification code are two-dimensional barcodes, and the identification module is a two-dimensional barcode scanner.

7. A place management system, comprising:
a cloud processing module configured to receive an entering request from a client;
an identification code generating module configured to generate a first identification code according to the entering request, and transmit the first identification code to the client by the cloud processing module; and
a identification module configured to determine whether the first identification code from the client is read, wherein an entering authorization message of a place corresponding to an object is generated when the first identification code is read by the identification module;
wherein the cloud processing module records a first time corresponding to the entering authorization message, the identification code generating module generates a second identification code according to the first time and a second time corresponding to a leaving message when the leaving message is received by the cloud processing module, the second identification code is transmitted to the client by the cloud processing module, and a leaving authorization message of the place corresponding to the object is generated when the second identification code is read by the identification module.

8. The place management system according to claim 7, further comprising:
a plurality of image capturing modules;
wherein the cloud processing module further reads position information of the object in the place and drives at least one of the plurality of image capturing modules to capture an image of the object according to the position information, and the cloud processing module transmits the image to the client.

9. The place management system according to claim 7, wherein the second identification code has an effective period.

10. The place management system according to claim 9, further comprising:
a toll module configured to receive a payment message and generate the leaving message according to the payment message.
